(19) United States
(12) Patent Application Publication
(10) Pub. No.: US 2026/0094135 A1
(43) Pub. Date: Apr. 2, 2026

(54) DECENTRALIZED IDENTITY PERMISSIONED PRIVACY ENHANCING TECHNOLOGY

(71) Applicant: HSBC Software Development (Guangdong) Limited, Guangdong (CN)

(72) Inventors: Benjamin Evans Chodroff, Shanghai (CN); Bing Qu, Guangzhou (CN); Ruxin Hou, Shanghai (CN); Wei Ming Zhuang, Shanghai (CN)

(21) Appl. No.: 19/414,106

(22) Filed: Dec. 9, 2025

(30) Foreign Application Priority Data
Dec. 31, 2024 (CN) 202411999123.0

(51) Int. Cl. G06Q 20/06; G06Q 20/38; G06Q 20/40

(52) U.S. Cl. CPC G06Q 20/0658; G06Q 20/381; G06Q 20/3829; G06Q 20/389; G06Q 20/4014; G06Q 20/405

(57) ABSTRACT

This disclosure provides techniques to utilize decentralized identifiers (DIDs) and verifiable credentials for secure, privacy-preserving transactions. In one aspect, a method is provided that includes: receiving user information; determining a DID based on the information; providing the DID to a user device; verifying the user's identity by validating the DID and associated verifiable credentials; and performing a transaction based on the verified DID. Other aspects are provided, such as generating a public-private key pair for the user, associating the DID with the public key, and/or creating a DID document stored on a distributed ledger accessible to authorized entities. Further aspects include processing transactions through smart contracts on a blockchain network, which may involve converting central bank digital currency to fiat currency while maintaining user privacy, applying transaction limits based on verified identity attributes, and providing zero-knowledge proofs to auditors to verify compliance without accessing underlying transaction details.

### CROSS-REFERENCE TO RELATED APPLICATIONS

This application claims priority to Chinese Patent Application No. 202411999123.0 filed on Dec. 31, 2024, the entire disclosure of which is hereby incorporated by reference in its entirety.

### BACKGROUND

With the rapid advancement of blockchain technology and the digitization of financial systems, digital currencies have emerged as an important component of the financial landscape. CBDCs are digital forms of a nation's sovereign currency issued and regulated by the central bank. They promise enhanced transaction efficiency, reduced costs, and financial inclusion.

### SUMMARY

The present disclosure relates to a system for digital currency transactions that integrates Distributed Identity (DID) and Privacy-Enhancing Technologies (PET) to enable secure, private, and compliant financial transactions on a blockchain network. The system comprises may be configured to provide decentralized identity verification and management, transaction privacy using cryptographic methods, managing and executing of transactions via a a smart contract according to predefined rules, connections to financial institutions, or a combination thereof. The system may also handle the issuance, circulation, and exchange of CBDC with fiat currency. In various aspects, described techniques may operate with one or more digital currencies or other tokenized fungible asset, including Central Bank Digital Currencies (CBDCs), stablecoins, tokenized deposits, or other forms of tokenized digital assets.

By leveraging DID, users can authenticate identities securely without exposing personal information to multiple institutions. The integration of PET ensures that transaction details remain confidential, preventing external observers from identifying the parties involved or the specific transaction amounts. The system aims to balance the need for transaction security and regulatory compliance with user privacy, addressing challenges in existing digital currency implementations.

In a first aspect, a method includes receiving, by a first computing device, user information associated with a user; determining, by the first computing device, a decentralized identifier (DID) associated with the user based on the user information; providing, by the first computing device, the DID to a user device associated with the user; verifying, by a second computing device, the identity of the user by validating the DID and associated verifiable credentials; and performing, by a third computing device, a transaction involving the user based on the verified DID.

In a second aspect according to the first aspect, wherein determining the DID includes generating a public-private key pair for the user; associating the DID with the public key of the public-private key pair; and creating a DID document containing the DID and the public key.

In a third aspect according to any one of the first or second aspects, wherein determining the DID further includes processing the user information to generate verifiable credentials containing identity attributes of the user; associating the verifiable credentials with the DID; and digitally signing the verifiable credentials using a private key of an issuing entity.

In a fourth aspect according to any one of the second or third aspects, the method further includes storing the DID document on a distributed ledger accessible to authorized entities.

In a fifth aspect according to any one of the first through fourth aspects, wherein verifying the identity of the user includes receiving, by the second computing device, the verifiable credentials associated with the DID; validating the verifiable credentials using cryptographic signatures associated with the issuing entity; and determining whether the user meets predefined compliance requirements based on the identity attributes in the verifiable credentials.

In a sixth aspect according to any one of the first through fifth aspects, wherein performing the transaction includes initiating, by the user device, a transaction request comprising the DID; and processing the transaction request through a smart contract deployed on a blockchain network.

In a seventh aspect according to any one of the first through sixth aspects, wherein performing the transaction includes converting digital currency to fiat currency while maintaining user privacy.

In an eighth aspect according to any one of the first through seventh aspects, wherein performing the transaction includes determining whether the transaction exceeds predefined transaction limits associated with the user's verified identity attributes; and rejecting the transaction upon determining that the transaction exceeds the transaction limits.

In a ninth aspect according to any one of the first through eighth aspects, the method further includes providing zero-knowledge proofs to auditors to verify compliance without accessing underlying transaction details.

In a tenth aspect according to any one of the first through ninth aspects, wherein the user information includes identification documents provided in compliance with Know Your Customer (KYC) requirements.

In an eleventh aspect according to any one of the first through tenth aspects, the method further includes updating the DID or associated verifiable credentials in response to changes in the user's identity information or compliance status.

In a twelfth aspect, a method includes deploying, by a computing device, a smart contract on a blockchain network, the smart contract configured to verify decentralized identifiers (DIDs) and associated verifiable credentials of users involved in transactions; enforce compliance rules for transactions based on verified identity attributes; and process transactions involving digital currency transfers between users based on associated DIDs; interacting with the smart contract to initiate transactions according to requests received from user devices; and executing, by the smart contract, the transactions upon successful verification and compliance checks.

In a thirteenth aspect according to the twelfth aspect, wherein executing the transaction includes receiving, by the smart contract deployed on the blockchain network, a transaction that transfers a first amount of a first digital asset from a user device associated with the user; and crediting, by the smart contract, an internal ledger with a second amount of a second digital asset associated with the user's DID, wherein the second amount is determined based on the first amount.

In a fourteenth aspect according to the thirteenth aspect, the method further includes updating, by the smart contract, balances in the internal ledger to reflect transactions involving the second digital asset without transferring actual tokens to user devices.

In a fifteenth aspect according to any one of the thirteenth or fourteenth aspects, wherein executing the transaction further includes debiting, by the smart contract, the user's balance of the second digital asset in the internal ledger upon initiation of a subsequent transaction; and crediting, by the smart contract, a recipient's balance of the second digital asset in the internal ledger.

In a sixteenth aspect according to the twelfth aspect, wherein the DID is issued by an authorized and regulated entity selected from the group consisting of financial institutions, government agencies, or other regulated bodies.

In a seventeenth aspect according to the twelfth aspect, wherein the smart contract includes an identity verification module interfacing with a distributed identity module to access DID documents and validate verifiable credentials.

In an eighteenth aspect according to the twelfth aspect, wherein enforcing compliance rules includes determining transaction limits for users based on their verified identity attributes; rejecting transactions that exceed the determined transaction limits; or both.

In a nineteenth aspect according to the twelfth aspect, wherein the smart contract is configured to check transactions against sanction lists obtained from authorized sources that are regularly updated; determine whether any party involved in the transaction is identified as a sanctioned entity; and reject the transaction if the transaction involves a sanctioned entity.

In a twentieth aspect according to the nineteenth aspect, wherein the sanction lists are updated dynamically by retrieving updated sanction lists from regulatory authorities or trusted data feeds.

In a twenty-first aspect according to the nineteenth aspect, wherein determining whether the transaction is prohibited includes analyzing the DIDs of parties involved in the transaction; comparing the DIDs against the sanction lists; and flagging the transaction if a match is found.

In a twenty-second aspect according to the twelfth aspect, wherein the smart contract processes privacy-enhanced transactions by verifying zero-knowledge proofs provided by the users without accessing sensitive transaction data.

In a twenty-third aspect according to the twenty-second aspect, the method further includes maintaining anonymized state updates on the blockchain network to preserve transaction privacy.

In a twenty-fourth aspect according to the twelfth aspect, the method further includes updating compliance parameters within the smart contract through authorized administrative functions in response to changes in regulatory requirements.

In a twenty-fifth aspect according to the twelfth aspect, wherein executing transactions involves transferring one or more currency tokens between user accounts on the blockchain network upon successful verification.

In a twenty-sixth aspect, a method includes generating, by a user device, a digital wallet associated with a user, the digital wallet configured to manage cryptographic keys for decentralized identity (DID), privacy-enhancing transactions, and blockchain transactions; linking, by the user device, the digital wallet to the DID; and performing, by the user device, transactions on a blockchain network using the digital wallet while maintaining security and privacy.

In a twenty-seventh aspect according to the twenty-sixth aspect, wherein generating the digital wallet includes generating a hierarchical deterministic (HD) wallet that generates multiple cryptographic keys from a seed.

In a twenty-eighth aspect according to any one of the twenty-sixth or twenty-seventh aspects, wherein the digital wallet supports multiple currencies.

In a twenty-ninth aspect according to any one of the twenty-sixth through twenty-eighth aspects, the method further includes providing, by the user device, notifications and real-time updates on transaction statuses and regulatory compliance checks.

In a thirtieth aspect, a system includes a processor and a memory storing instructions which, when executed by the processor, cause the processor to perform operations including receiving, by a first computing device, user information associated with a user; determining, by the first computing device, a decentralized identifier (DID) associated with the user based on the user information; providing, by the first computing device, the DID to a user device associated with the user; verifying, by a second computing device, the identity of the user by validating the DID and associated verifiable credentials; and performing, by a third computing device, a transaction involving the user based on the verified DID.

In a thirty-first aspect according to the thirtieth aspect, wherein determining the DID includes generating a public-private key pair for the user; associating the DID with the public key of the public-private key pair; and creating a DID document containing the DID and the public key.

In a thirty-second aspect according to the thirtieth aspect, wherein determining the DID further includes processing the user information to generate verifiable credentials containing identity attributes of the user; associating the verifiable credentials with the DID; and digitally signing the verifiable credentials using a private key of an issuing entity.

In a thirty-third aspect according to any one of the thirty-first or thirty-second aspects, the system further includes storing the DID document on a distributed ledger accessible to authorized entities.

In a thirty-fourth aspect according to any one of the thirtieth through thirty-third aspects, wherein verifying the identity of the user includes receiving, by the second computing device, the verifiable credentials associated with the DID; validating the verifiable credentials using cryptographic signatures associated with the issuing entity; and determining whether the user meets predefined compliance requirements based on the identity attributes in the verifiable credentials.

In a thirty-fifth aspect according to any one of the thirtieth through thirty-fourth aspects, wherein performing the transaction includes initiating, by the user device, a transaction request comprising the DID; and processing the transaction request through a smart contract deployed on a blockchain network.

In a thirty-sixth aspect according to any one of the thirtieth through thirty-fifth aspects, wherein performing the transaction includes converting digital currency to fiat currency while maintaining user privacy.

In a thirty-seventh aspect according to any one of the thirtieth through thirty-sixth aspects, wherein performing the transaction includes determining whether the transaction exceeds predefined transaction limits associated with the user's verified identity attributes; and rejecting the transaction upon determining that the transaction exceeds the transaction limits.

In a thirty-eighth aspect according to any one of the thirtieth through thirty-seventh aspects, the system further includes providing zero-knowledge proofs to auditors to verify compliance without accessing underlying transaction details.

In a thirty-ninth aspect according to any one of the thirtieth through thirty-eighth aspects, wherein the user information includes identification documents provided in compliance with Know Your Customer (KYC) requirements.

In a fortieth aspect according to any one of the thirtieth through thirty-ninth aspects, the system further includes updating the DID or associated verifiable credentials in response to changes in the user's identity information or compliance status.

In a forty-first aspect, a non-transitory, computer-readable medium stores instructions which, when executed by a processor, cause the processor to perform operations including receiving, by a first computing device, user information associated with a user; determining, by the first computing device, a decentralized identifier (DID) associated with the user based on the user information; providing, by the first computing device, the DID to a user device associated with the user; verifying, by a second computing device, the identity of the user by validating the DID and associated verifiable credentials; and performing, by a third computing device, a transaction involving the user based on the verified DID.

In a forty-second aspect according to the forty-first aspect, wherein determining the DID includes generating a public-private key pair for the user; associating the DID with the public key of the public-private key pair; and creating a DID document containing the DID and the public key.

In a forty-third aspect according to the forty-first aspect, wherein determining the DID further includes processing the user information to generate verifiable credentials containing identity attributes of the user; associating the verifiable credentials with the DID; and digitally signing the verifiable credentials using a private key of an issuing entity.

In a forty-fourth aspect according to any one of the forty-second or forty-third aspects, the method further includes storing the DID document on a distributed ledger accessible to authorized entities.

In a forty-fifth aspect according to any one of the forty-first through forty-fourth aspects, wherein verifying the identity of the user includes receiving, by the second computing device, the verifiable credentials associated with the DID; validating the verifiable credentials using cryptographic signatures associated with the issuing entity; and determining whether the user meets predefined compliance requirements based on the identity attributes in the verifiable credentials.

In a forty-sixth aspect according to any one of the forty-first through forty-fifth aspects, wherein performing the transaction includes initiating, by the user device, a transaction request comprising the DID; and processing the transaction request through a smart contract deployed on a blockchain network.

In a forty-seventh aspect according to any one of the forty-first through forty-sixth aspects, wherein performing the transaction includes converting digital currency to fiat currency while maintaining user privacy.

In a forty-eighth aspect according to any one of the forty-first through forty-seventh aspects, wherein performing the transaction includes determining whether the transaction exceeds predefined transaction limits associated with the user's verified identity attributes; and rejecting the transaction upon determining that the transaction exceeds the transaction limits.

In a forty-ninth aspect according to any one of the forty-first through forty-eighth aspects, the method further includes providing zero-knowledge proofs to auditors to verify compliance without accessing underlying transaction details.

In a fiftieth aspect according to any one of the forty-first through forty-ninth aspects, wherein the user information includes identification documents provided in compliance with Know Your Customer (KYC) requirements.

In a fifty-first aspect according to any one of the forty-first through fiftieth aspects, the method further includes updating the DID or associated verifiable credentials in response to changes in the user's identity information or compliance status.

In a fifty-second aspect, a system includes a processor and a memory storing instructions which, when executed by the processor, cause the processor to perform operations including deploying, by a computing device, a smart contract on a blockchain network, the smart contract configured to verify decentralized identifiers (DIDs) and associated verifiable credentials of users involved in transactions; enforce compliance rules for transactions based on verified identity attributes; and process transactions involving digital currency transfers between users based on associated DIDs; interacting with the smart contract to initiate transactions according to requests received from user devices; and executing, by the smart contract, the transactions upon successful verification and compliance checks.

In a fifty-third aspect according to the fifty-second aspect, wherein executing the transaction includes receiving, by the smart contract deployed on the blockchain network, a transaction that transfers a first amount of a first digital asset from a user device associated with the user; and crediting, by the smart contract, an internal ledger with a second amount of a second digital asset associated with the user's DID, wherein the second amount is determined based on the first amount.

In a fifty-fourth aspect according to the fifty-third aspect, the system further includes updating, by the smart contract, balances in the internal ledger to reflect transactions involving the second digital asset without transferring actual tokens to user devices.

In a fifty-fifth aspect according to any one of the fifty-third or fifty-fourth aspects, wherein executing the transaction further includes debiting, by the smart contract, the user's balance of the second digital asset in the internal ledger upon initiation of a subsequent transaction; and crediting, by the smart contract, a recipient's balance of the second digital asset in the internal ledger.

In a fifty-sixth aspect according to the fifty-second aspect, wherein the DID is issued by an authorized and regulated entity selected from the group consisting of financial institutions, government agencies, or other regulated bodies.

In a fifty-seventh aspect according to the fifty-second aspect, wherein the smart contract includes an identity verification module interfacing with a distributed identity module to access DID documents and validate verifiable credentials.

In a fifty-eighth aspect according to the fifty-second aspect, wherein enforcing compliance rules includes determining transaction limits for users based on their verified identity attributes; rejecting transactions that exceed the determined transaction limits; or both.

In a fifty-ninth aspect according to the fifty-second aspect, wherein the smart contract is configured to check transactions against sanction lists obtained from authorized sources that are regularly updated; determine whether any party involved in the transaction is identified as a sanctioned entity; and reject the transaction if the transaction involves a sanctioned entity.

In a sixtieth aspect according to the fifty-ninth aspect, wherein the sanction lists are updated dynamically by retrieving updated sanction lists from regulatory authorities or trusted data feeds.

In a sixty-first aspect according to the fifty-ninth aspect, wherein determining whether the transaction is prohibited includes analyzing the DIDs of parties involved in the transaction; comparing the DIDs against the sanction lists; and flagging the transaction if a match is found.

In a sixty-second aspect according to the fifty-second aspect, wherein the smart contract processes privacy-enhanced transactions by verifying zero-knowledge proofs provided by the users without accessing sensitive transaction data.

In a sixty-third aspect according to the sixty-second aspect, the system further includes maintaining anonymized state updates on the blockchain network to preserve transaction privacy.

In a sixty-fourth aspect according to the fifty-second aspect, the system further includes updating compliance parameters within the smart contract through authorized administrative functions in response to changes in regulatory requirements.

In a sixty-fifth aspect according to the fifty-second aspect, wherein executing transactions involves transferring one or more currency tokens between user accounts on the blockchain network upon successful verification.

In a sixty-sixth aspect, a non-transitory, computer-readable medium stores instructions which, when executed by a processor, cause the processor to perform operations including deploying, by a computing device, a smart contract on a blockchain network, the smart contract configured to verify decentralized identifiers (DIDs) and associated verifiable credentials of users involved in transactions; enforce compliance rules for transactions based on verified identity attributes; and process transactions involving digital currency transfers between users based on associated DIDs; interacting with the smart contract to initiate transactions according to requests received from user devices; and executing, by the smart contract, the transactions upon successful verification and compliance checks.

In a sixty-seventh aspect according to the sixty-sixth aspect, wherein executing the transaction includes receiving, by the smart contract deployed on the blockchain network, a transaction that transfers a first amount of a first digital asset from a user device associated with the user; and crediting, by the smart contract, an internal ledger with a second amount of a second digital asset associated with the user's DID, wherein the second amount is determined based on the first amount.

In a sixty-eighth aspect according to the sixty-seventh aspect, the method further includes updating, by the smart contract, balances in the internal ledger to reflect transactions involving the second digital asset without transferring actual tokens to user devices.

In a sixty-ninth aspect according to any one of the sixty-seventh or sixty-eighth aspects, wherein executing the transaction further includes debiting, by the smart contract, the user's balance of the second digital asset in the internal ledger upon initiation of a subsequent transaction; and crediting, by the smart contract, a recipient's balance of the second digital asset in the internal ledger.

In a seventieth aspect according to the sixty-sixth aspect, wherein the DID is issued by an authorized and regulated entity selected from the group consisting of financial institutions, government agencies, or other regulated bodies.

In a seventy-first aspect according to the sixty-sixth aspect, wherein the smart contract includes an identity verification module interfacing with a distributed identity module to access DID documents and validate verifiable credentials.

In a seventy-second aspect according to the sixty-sixth aspect, wherein enforcing compliance rules includes determining transaction limits for users based on their verified identity attributes; rejecting transactions that exceed the determined transaction limits; or both.

In a seventy-third aspect according to the sixty-sixth aspect, wherein the smart contract is configured to check transactions against sanction lists obtained from authorized sources that are regularly updated; determine whether any party involved in the transaction is identified as a sanctioned entity; and reject the transaction if the transaction involves a sanctioned entity.

In a seventy-fourth aspect according to the seventy-third aspect, wherein the sanction lists are updated dynamically by retrieving updated sanction lists from regulatory authorities or trusted data feeds.

In a seventy-fifth aspect according to the seventy-third aspect, wherein determining whether the transaction is prohibited includes analyzing the DIDs of parties involved in the transaction; comparing the DIDs against the sanction lists; and flagging the transaction if a match is found.

In a seventy-sixth aspect according to the sixty-sixth aspect, wherein the smart contract processes privacy-enhanced transactions by verifying zero-knowledge proofs provided by the users without accessing sensitive transaction data.

In a seventy-seventh aspect according to the seventy-sixth aspect, the method further includes maintaining anonymized state updates on the blockchain network to preserve transaction privacy.

In a seventy-eighth aspect according to the sixty-sixth aspect, the method further includes updating compliance parameters within the smart contract through authorized administrative functions in response to changes in regulatory requirements.

In a seventy-ninth aspect according to the sixty-sixth aspect, wherein executing transactions involves transferring one or more currency tokens between user accounts on the blockchain network upon successful verification.

In an eightieth aspect, a system includes a processor and a memory storing instructions which, when executed by the processor, cause the processor to perform operations including generating, by a user device, a digital wallet associated with a user, the digital wallet configured to manage cryptographic keys for decentralized identity (DID), privacy-enhancing transactions, and blockchain transactions; linking, by the user device, the digital wallet to the DID; and performing, by the user device, transactions on a blockchain network using the digital wallet while maintaining security and privacy.

In an eighty-first aspect according to the eightieth aspect, wherein generating the digital wallet includes generating a hierarchical deterministic (HD) wallet that generates multiple cryptographic keys from a seed.

In an eighty-second aspect according to any one of the eightieth or eighty-first aspects, wherein the digital wallet supports multiple currencies.

In an eighty-third aspect according to any one of the eightieth through eighty-second aspects, the system further includes providing, by the user device, notifications and real-time updates on transaction statuses and regulatory compliance checks.

In an eighty-fourth aspect, a non-transitory, computer-readable medium stores instructions which, when executed by a processor, cause the processor to perform operations including generating, by a user device, a digital wallet associated with a user, the digital wallet configured to manage cryptographic keys for decentralized identity (DID), privacy-enhancing transactions, and blockchain transactions; linking, by the user device, the digital wallet to the DID; and performing, by the user device, transactions on a blockchain network using the digital wallet while maintaining security and privacy.

In an eighty-fifth aspect according to the eighty-fourth aspect, wherein generating the digital wallet includes generating a hierarchical deterministic (HD) wallet that generates multiple cryptographic keys from a seed.

In an eighty-sixth aspect according to any one of the eighty-fourth or eighty-fifth aspects, wherein the digital wallet supports multiple currencies.

In an eighty-seventh aspect according to any one of the eighty-fourth through eighty-sixth aspects, the non-transitory, computer-readable medium further stores instructions which, when executed by the processor, cause the processor to perform operations including providing, by the user device, notifications and real-time updates on transaction statuses and regulatory compliance checks.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system for privacy enhanced transactions according to one aspect of the present disclosure.

FIG. 2 illustrates a system for smart contract administration for privacy enhanced transactions according to one aspect of the present disclosure.

FIG. 3 illustrates a system for user verification and identification for privacy enhanced transactions according to one aspect of the present disclosure.

FIG. 4 illustrates a method for privacy enhanced transactions according to one aspect of the present disclosure.

FIG. 5 illustrates a method for smart contract administration for privacy enhanced transactions according to one aspect of the present disclosure.

FIG. 6 illustrates a method for user verification and identification for privacy enhanced transactions according to one aspect of the present disclosure.

FIG. 7 illustrates a computer system according to one aspect of the present disclosure.

### DETAILED DESCRIPTION OF EXAMPLE EMBODIMENTS

Existing CBDC systems often face challenges in balancing transaction security, regulatory compliance, and user privacy. Traditional blockchain technologies, while offering transparency and traceability, make all or most transaction details publicly visible on the ledger. This transparency can lead to privacy breaches, as sensitive user information and transaction data become accessible to external parties. Users requiring confidentiality in their financial dealings may be deterred by this lack of privacy.

Moreover, current identity verification processes are typically centralized, relying on databases controlled by banks or government institutions. These centralized systems are vulnerable to data breaches, unauthorized access, and single points of failure, compromising user privacy and system security. Users often need to repeatedly provide personal information when accessing services across different banks, leading to inefficiencies and increased risk of data exposure.

Additionally, while privacy is essential, regulatory compliance necessitates a certain level of traceability to prevent illicit activities such as money laundering and fraud. Existing systems struggle to provide robust privacy protections without compromising the ability to meet regulatory obligations. The lack of interoperability between banks further complicates the issue, as siloed identity verification processes hinder seamless user experiences across financial institutions. One solution to this problem is to integrate Distributed Identity (DID) and

Privacy-Enhancing Technologies (PET) within a digital currency system to enhance user privacy while maintaining transaction security and compliance. The present techniques utilize decentralized identity management, allowing users to securely control their identity information. In particular, the present techniques may combine identity verification using DIDs with privacy-enhancing smart contracts to enable permissioned privacy in digital currency transactions. By associating user identities with cryptographic key pairs and storing identifiers on a distributed ledger, the system reduces reliance on centralized databases and mitigates the risks of data breaches and unauthorized access.

Advanced cryptographic methods such as Zero-Knowledge Proofs (ZKPs) are employed to ensure transaction privacy. This integration allows users to conduct transactions where identities and amounts are concealed, preventing external observers from identifying the transacting parties or analyzing transaction flows. By using privacy agents and anonymized accounts, the system enables privacy-enhanced transactions that comply with regulatory requirements through selective disclosure and secure verification processes.

Compliance is enforced by encoding regulatory rules and verifying transactions according to predefined policies. The system interacts with the decentralized identity management and privacy-enhancing frameworks to ensure that only authenticated and authorized users can perform transactions, and that all activities adhere to Anti-Money Laundering (AML) and Know Your Customer (KYC) regulations. This interconnected approach addresses the limitations of existing systems by providing a scalable and interoperable solution that balances privacy, security, and compliance.

In some aspects, the present disclosure provides techniques for enhancing privacy and security in CBDC transactions through the integration of Distributed Identity and Privacy-Enhancing Technologies. These techniques may be particularly beneficial in financial systems where user privacy and regulatory compliance are paramount. For example, users can perform confidential transactions without exposing personal information or transaction details, reducing the risk of privacy breaches and unauthorized data access.

By decentralizing identity management using DID, the described techniques may improve the user experience by allowing seamless access to services across different banks without repeated identity verifications. The interoperability facilitated by adherence to standards ensures that users can interact with multiple financial institutions securely and efficiently. Furthermore, the use of smart contracts automates compliance enforcement and transaction processing, which may enhance the overall efficiency and reliability of the financial system.

The integration of PET protects sensitive transaction data while maintaining the integrity and traceability required for regulatory purposes. Users gain flexibility in choosing between standard and privacy-enhanced transactions, aligning with their privacy needs. Additionally, the system's scalability and performance optimizations may improve the functioning of the underlying blockchain infrastructure, supporting high transaction volumes without compromising security or privacy.

The approaches proposed herein can be utilized for various practical applications, integrating specific implementations of the technology to enhance security, privacy, and regulatory compliance in digital currency transactions. In particular, the methods described leverage decentralized identifiers (DIDs) and privacy-enhancing technologies (PET) within blockchain networks to address challenges associated with traditional digital currency systems, such as exposure of sensitive user information and difficulties in balancing privacy with regulatory compliance.

For example, a user wants to send digital currency to a friend in another country. Using the system described, the user's financial institution generates a DID after verifying identity in compliance with KYC requirements. The transaction proceeds securely through a smart contract that verifies the DID and ensures regulatory compliance without exposing personal data.

In one example, the techniques involve utilizing DIDs and verifiable credentials to authenticate users securely without revealing personal information to multiple entities. A user registers with an authorized issuing entity, such as a financial institution or governmental agency, providing user information that complies with Know Your Customer (KYC) requirements. The system processes this information to generate a DID associated with the user by creating a public-private key pair and associating the DID with the public key. A DID document containing the DID and public key is stored on a distributed ledger accessible to authorized entities.

For instance, when a user registers with a bank's digital platform, they provide identification documents and biometric data. The bank generates a DID for the user and stores it on a secure blockchain ledger. Later, when the user initiates a transaction, their identity is verified using the DID and verifiable credentials, streamlining the process and enhancing security.

The user device receives the DID and associated verifiable credentials, which include digitally signed identity attributes. When performing transactions, the user initiates a transaction request comprising the DID. The system verifies the identity of the user by validating the DID and associated credentials using cryptographic signatures. Compliance checks are conducted by determining whether the user meets predefined requirements based on the identity attributes in the verifiable credentials.

As an example, a user wants to make a large purchase using digital currency. The digital wallet sends a transaction request with the user's DID. The system validates the credentials and ensures the user meets the necessary compliance requirements for high-value transactions, allowing the purchase to proceed smoothly.

This method allows for secure and private digital currency transactions, as the user's identity is verified without exposing sensitive personal data. The integration of DIDs reduces reliance on centralized databases, mitigating risks of data breaches and unauthorized access.

For example, a user transacts with new vendors without worrying about revealing personal information. The DID and verifiable credentials enable secure authentication while maintaining privacy, reducing the risk of identity theft or fraud.

In another example, the approaches involve deploying a smart contract on a blockchain network configured to verify DIDs and enforce compliance rules. The smart contract processes transactions involving digital currency transfers between users based on their associated DIDs. It enforces compliance by determining transaction limits based on verified identity attributes and rejecting transactions that exceed these limits. The smart contract also checks transactions against sanction lists obtained from authorized sources that are regularly updated, rejecting any transactions involving sanctioned entities.

For instance, a user attempts to send funds to a new business partner overseas. The smart contract verifies both parties'DIDs and runs compliance checks. By accessing updated sanction lists, the system ensures that neither party is flagged, allowing the transaction to proceed securely.

Additionally, the methods proposed are utilized to enforce compliance in high-value transactions. A smart contract determines transaction limits for users based on their verified identity attributes and rejects transactions exceeding these limits. It checks transactions against sanction lists and rejects any involving sanctioned entities. Compliance parameters within the smart contract can be updated through authorized administrative functions in response to changes in regulatory requirements. This dynamic capability allows the system to remain compliant while maintaining operational efficiency.

For example, regulatory changes lower transaction limits for certain users. The smart contract is updated accordingly. When a user, whose identity attributes now place them in a lower limit category, attempts a large transaction, it's automatically declined. The user is prompted to complete additional verification to restore higher transaction limits, ensuring compliance with new regulations.

The approaches also facilitate updating DIDs and associated verifiable credentials in response to changes in a user's identity information or compliance status. Users can securely update their information through their user device, with the system processing the updates and securely storing the new DID documents on the distributed ledger. This ensures that authorized entities have access to the most current information, maintaining data integrity and compliance across different jurisdictions.

For instance, after moving to a new country, a user updates their address and residency status through the digital wallet. The system securely updates the DID and credentials, ensuring future transactions comply with local regulations and avoiding potential compliance issues.

In summary, the approaches proposed herein provide comprehensive solutions for enhancing cybersecurity, privacy, and regulatory compliance in digital currency transactions. By integrating decentralized identity verification and privacy-enhancing technologies into blockchain networks, the methods address key challenges in existing digital currency implementations. The techniques enable users to conduct secure and private transactions, manage digital assets effectively, and ensure compliance with evolving regulatory standards, thereby facilitating practical, real-world applications in the digital finance landscape.

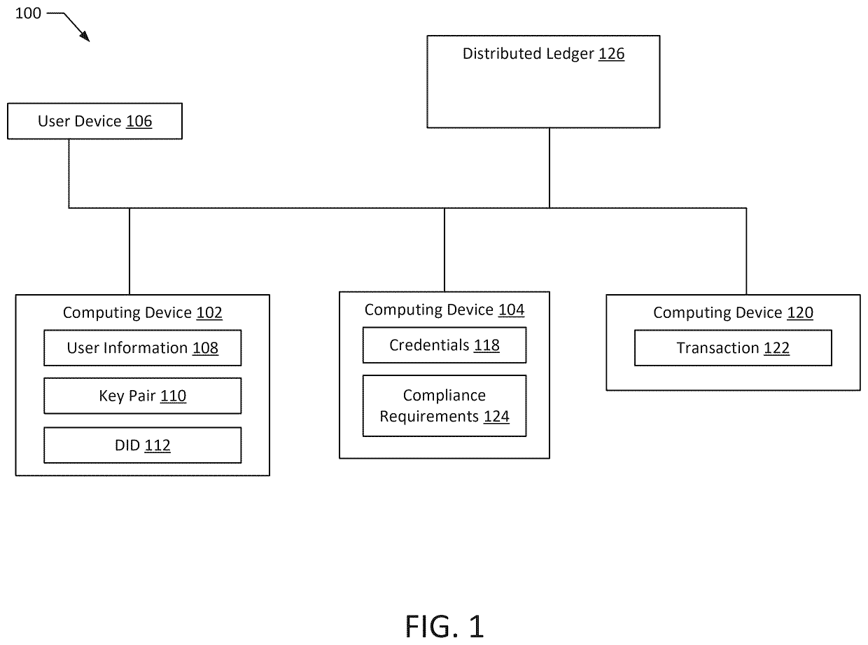

FIG. 1 depicts a system 100 according to one aspect of the present disclosure. The system 100 includes a user device 106 associated with a user, a first computing device 102, a second computing device 104, a third computing device 120, and a distributed ledger 126.

The user device 106 may be any suitable computing device, such as a smartphone, tablet, or personal computer, through which the user interacts with the system. The first computing device 102, second computing device 104, and third computing device 120 may be server computers, cloud computing resources, or any suitable computing systems configured to perform specific functions within the system 100. For example, the first computing device 102 may be associated with an issuing authority such as a bank or governmental organization responsible for generating decentralized identifiers (DIDs) and verifiable credentials (VCs). The second computing device 104 may be associated with service providers or entities that need to verify the user's identity and compliance status. The third computing device 120 may be part of a transaction processing network, handling transactions involving the user based on the verified DID 112. Additional details of these computing devices are provided below and illustrated in FIG. 11.

The first computing device 102 is configured to receive user information 108 associated with the user. The user information 108 may include identification documents provided in compliance with Know Your Customer (KYC) requirements. For example, the user may submit personal details such as name, address, date of birth, government-issued identification numbers, biometric data, and the like. The user information 108 may be received via a user interface on the user device 106, such as a mobile application or web portal that guides the user through the registration process. For instance, the user may capture images of their identification documents using the device's camera or enter required information manually. The interface may also allow the user to provide biometric data, such as fingerprints or facial recognition scans, to enhance security. This initial registration sets the foundation for secure payment and transaction use cases described further below.

### Decentralized Identifier Determination

The first computing device 102 determines a decentralized identifier (DID) 112 associated with the user based on the user information 108. In certain implementations, DIDs 112 may be issued by an authorized entity. Authorized entities that can issue DIDs may include financial institutions, government agencies, or other regulated bodies, ensuring trust and compliance in the system. Verifiable credentials and/or DIDs 112 may be digitally signed by the issuing entity, which is an authorized and regulated entity, such as a bank or governmental authority.

The determination process may include generating a public-private key pair 110 for the user. The public-private key pair 110 may be generated using cryptographic algorithms such as Elliptic Curve Cryptography (ECC) or RSA. For example, the first computing device 102 may use the ECC algorithm with a curve like secp256k1 to generate the keys in response to receiving the user information 108.

The public key from the public-private key pair 110 is associated with the DID 112. The DID 112 may refer to a unique identifier conforming to a particular standard, such as the World Wide Web Consortium (W3C) Decentralized Identifier (DID) specification, which serves as a reference to the user's decentralized identity without revealing personal information. A decentralized identity may refer to a self-sovereign identity model where users have control over their own identity information without reliance on a central authority.

A DID document 114 is then created, containing the DID 112 and the associated public key. The DID Document 114 may include metadata, authentication methods, and service endpoints relevant to the user's identity. For example, the DID Document 114 might specify the cryptographic methods that can be used to authenticate the user, such as public keys or verification methods, and include service endpoints for interacting with the identity, like URLs for obtaining verifiable credentials.

Additionally, the first computing device 102 may process the user information 108 to generate verifiable credentials 118 containing identity attributes of the user. The verifiable credentials 118 may include claims such as the user's name, date of birth, and citizenship status. For example, a verifiable credential may state that the user is over 18 years old, a resident of a specific country, and has a valid driver's license, all cryptographically signed by the issuing authority. These credentials are digitally signed using a private key of an issuing entity, such as a bank or governmental authority, to ensure authenticity and integrity. Digital signatures may be applied using standards like JSON Web Tokens (JWT) or JSON-LD Signatures.

The DID document 114 is then securely stored on the distributed ledger 126, which may be a blockchain network accessible to authorized entities. The distributed ledger 126 may be implemented using blockchain platforms like Ethereum, Hyperledger Fabric, or others that support smart contracts and data immutability. Authorized entities could include financial institutions, regulatory bodies, or service providers that have permissions to read or interact with certain data on the ledger. The use of a distributed ledger 126 ensures immutability and transparency while maintaining user privacy through cryptographic techniques. To securely store the DID Document 114 on the distributed ledger 126, the system may utilize hash functions to record a fingerprint of the document without exposing sensitive details. For example, the DID document 114 may be hashed using SHA-256, and the resulting hash stored on the ledger, allowing verification of the document's integrity without revealing its contents.

### Providing the DID to the User Device

The first computing device 102 provides the DID 112 to the user device 106 associated with the user. Secure transmission methods, such as end-to-end encryption or secure APIs, are used to deliver the DID 112 and associated credentials to the user device 106. The user device 106 stores and manages the DID 112 and the private key from the public-private key pair 110 using secure storage methods. This may involve utilizing hardware security modules (HSMs), secure enclaves, or encrypted storage solutions to protect cryptographic keys.

The user may interact with a wallet application on the user device 106 that manages identities, keys, and transactions. Authentication mechanisms like biometric authentication (e.g., fingerprint or facial recognition) or multi-factor authentication (MFA) may be employed to safeguard access to the DID 112 and related credentials, as discussed further below.

### Identity Verification

The second computing device 104 may be configured to verify the identity of the user by validating the DID 112 and associated verifiable credentials 118. The verification process involves receiving the verifiable credentials 118 from the user device 106 through secure communication protocols, such as HTTPS or secure messaging frameworks. In particular, the second computing device 104 may be configured to ensure that the user possess a valid DID issued by a regulated entity to participate in privacy-preserving transactions, ensuring that only authorized users can access the privacy features.

The second computing device 104 validates the digital signatures on the verifiable credentials 118 using cryptographic methods corresponding to the issuing entity's public key. In general, this involves retrieving the issuer's public key, which may be obtained from the issuer's DID Document on the distributed ledger 126, and using it to verify the signature on the verifiable credentials 118. This ensures that the credentials were indeed issued by the trusted authority and have not been altered. Such verification may ensure that the credentials are authentic and have not been altered. Verification algorithms may involve signature verification techniques provided by cryptographic libraries. For example, if the verifiable credentials are signed using ECDSA (Elliptic Curve Digital Signature Algorithm), the second computing device 104 uses an ECDSA verification function from a cryptographic library to validate the signature.

The second computing device 104 then determines whether the user meets one or more predefined compliance requirements 124 based on the identity attributes present in the verifiable credentials 118. Compliance requirements 124 may refer to regulatory conditions that users must satisfy to perform certain transactions or access services. These requirements are defined by laws and regulations pertinent to the jurisdiction, such as KYC, AML, and CFT regulations. Compliance requirements 124 may include age verification, residency status, sanctions screening, and/or other regulatory criteria mandated by laws such as Anti-Money Laundering (AML) and Combating the Financing of Terrorism (CFT) regulations.

For example, if the user is attempting to perform a transaction that requires the user to be over 18 years old, the second computing device 104 checks the date of birth attribute in the verifiable credentials 118 to confirm eligibility. If the user does not meet the compliance requirements 124, appropriate actions are taken, such as denying the transaction and notifying the user. The verification process may involve parsing the verifiable credential to extract the date of birth, calculating the user's age, and comparing it against the minimum required age. The system may log the verification attempt and provide feedback to the user through the user device 106, indicating the reason for denial and any steps necessary to rectify the situation. As another example, the second computing device 104 may perform sanctions screening by comparing the user's identity attributes against a list of sanctioned individuals provided by government agencies. If a match is found, the system will block the transaction and may report the attempt to the appropriate authorities as required by law.

In certain implementations, the first computing device 102 may be configured to perform one or more of the functions of the second computing device 104. For instance, in a system where the issuing authority is also the service provider, the first computing device 102 may handle both the generation of DIDs and the verification of identities. In such cases, the system 100 may not include a separate second computing device 104. For example, a banking institution might use the first computing device 102 to issue verifiable credentials to its customers and also verify those credentials when customers initiate transactions or access services within that bank's ecosystem.

### Transaction Processing

The third computing device 120 performs a transaction 122 involving the user based on the verified DID 112. The user initiates a transaction request from the user device 106, which includes the DID 112 and necessary transaction details. The transaction request may involve transferring funds, accessing services, or other operations facilitated by the system 100. For example, the user may use the wallet application on the user device 106 to send a payment to another user by selecting the recipient, entering the amount, and authorizing the transaction using biometric authentication. The transaction details, along with the user's DID 112, are then sent to the third computing device 120 for processing.

The transaction request is processed through a smart contract deployed on a blockchain network, which may be part of the distributed ledger 126. The smart contract contains code that enforces the rules and logic governing transactions, ensuring transparency and immutability. In certain implementations, the system allows for the off-ramp (withdrawal from the privacy smart contract) to be configured as either permissioned (e.g., requiring DID verification), or permissionless (e.g., not requiring DID verification), such as depending on regulatory requirements.

In certain implementations, when a user initiates a transaction involving digital currency (e.g., a first digital asset), the user device 106 sends an amount of the digital currency to the smart contract. The smart contract is configured to hold the digital currency and credit the user's internal balance with a corresponding amount of a second digital asset, such as a privacy token. The privacy token may represent a claim on the held digital currency and is recorded in the smart contract's internal ledger as unspent transaction outputs (UTXOs). In certain implementations, no actual tokens (e.g., privacy tokens) are transferred to the user's wallet; instead, the balance adjustment may occur within an internal ledger of the smart contract, enhancing privacy by avoiding on-chain transfers that could be linked to identities.

For example, suppose Alice wishes to send 100 units of digital currency to Bob privately. Alice's user device 106 sends a transaction to the smart contract, transferring 100 units of digital currency to the smart contract. The smart contract holds the digital currency and credits Alice's internal privacy token balance with 100 units of the privacy token. When Alice wants to transfer privacy tokens to Bob, she submits a transaction request to the smart contract, including encrypted instructions or zero-knowledge proofs. The smart contract verifies the validity of the request without revealing sensitive information, debits Alice's privacy token balance by 100 units, and credits Bob's internal privacy token balance with 100 units. Bob can later redeem the privacy tokens for digital currency held by the smart contract, subject to any off-ramp permissioning requirements.

Before executing the transaction 122, the smart contract may verify compliance with one or more regulatory rules. The smart contract enforces regulatory rules by incorporating them into the contract's code logic. It may access the user's verified identity attributes by interacting with the verifiable credentials 118 or retrieving necessary information securely. This may include checking the user's identity attributes and transaction details against predefined criteria encoded in the smart contract. For instance, the smart contract may enforce transaction limits based on the user's verified identity attributes, such as limiting the transaction amount for users who have not completed enhanced due diligence procedures. The smart contract may fetch the user's compliance status and compare the transaction amount with permitted limits. If the user has only completed basic KYC procedures, they may have a lower transaction limit compared to users who have undergone more rigorous verification.

If the transaction exceeds the predefined transaction limits associated with the user's compliance status, the smart contract rejects the transaction. The system may then notify the user through the user device 106, providing information about the reason for the rejection and any steps required to resolve the issue.

In certain implementations, the transaction 122 may involve converting central bank digital currency (CBDC) or other digital currencies to fiat currency through authorized channels while maintaining user privacy. The system facilitates this by securely interfacing with financial institutions and utilizing privacy-enhancing technologies, such as zero-knowledge proofs, to prevent disclosure of sensitive transaction details, as described further below.

### Regulatory Compliance Enforcement

One or more of the computing devices 102, 104, 120 may be configured to enforce regulatory compliance by applying transaction limits based on the user's verified identity attributes and compliance requirements 124. This includes checking the DID 112 against updated sanction lists obtained from authorized sources, such as government agencies or international organizations.

Sanction lists may be periodically retrieved and updated to ensure accuracy. The second computing device 104 compares the user's DID 112 with entries on the sanction lists. If the user is identified as a sanctioned user, the system prevents the user from performing transactions 122, and further measures are taken in accordance with legal obligations. For example, when a user attempts to initiate a transaction, the second computing device 104 may automatically compare the DID 112 against the latest sanction list. If a match is found, the system blocks the transaction and may freeze the user's account. Additionally, a notification may be sent to compliance officers or relevant authorities, along with relevant details for further investigation.

### Transaction Monitoring and Reporting

The computing devices in the system 100 may monitor transactions for suspicious activities using automated systems. This may include detecting patterns indicative of money laundering, fraud, or other illicit activities through analytics or machine learning algorithms. For example, the system may analyze transaction amounts, frequency, and counterparties to identify anomalous behaviors. Thresholds and rules are established to flag transactions that require further investigation. Flagged transactions may be reported to regulatory authorities in compliance with legal obligations while maintaining user privacy. The system uses secure reporting channels and may employ techniques such as data anonymization or aggregation to protect user identities during the reporting process.

### Privacy-Preserving Audits

The system 100 may also facilitate privacy-preserving audits by authorized entities without disclosing sensitive user data. This may be implemented by providing zero-knowledge proofs to auditors, allowing them to verify compliance with regulatory requirements without accessing underlying transaction details. Zero-knowledge proofs enable one party to prove to another that a statement is true without revealing any information beyond the validity of the statement itself. For instance, the system can prove that transaction limits have not been exceeded or that sanction list checks have been performed, without exposing user identities or specific transaction amounts.

The system 100 may maintain immutable audit logs of transactions and compliance checks in a secure ledger, such as the distributed ledger 126. These logs contain records of transaction timestamps, involved DIDs, compliance check results, and other relevant metadata. Access to the audit logs may be restricted to authorized personnel through access controls and authentication mechanisms. The use of a secure ledger ensures data integrity and compliance with data protection regulations, such as the General Data Protection Regulation (GDPR).

### Updating DIDs and Credentials

The system 100 supports updating the DID 112 or associated verifiable credentials 118 in response to changes in the user's identity information 108 or compliance status. This may occur when a user legally changes their name, updates their address, or completes additional verification procedures. The user can initiate updates through the user device 106, providing necessary documentation or information. The first computing device 102 processes the updates, regenerates verifiable credentials 118 as needed, and updates the DID Document 114 on the distributed ledger 126. Safeguards may be implemented to prevent unauthorized updates or tampering with identity information. This may include authentication measures, verification steps, and audit trails to track changes.

In certain implementations, the user device 106 may include a user interface that allows the user to manage their identity, view transaction history, and adjust privacy settings. The system may also support multi-signature transactions, where multiple parties approve a transaction, enhancing security for high-value operations. The computing devices 102, 104, and 120 may communicate over secure networks, utilizing encryption and authentication protocols to protect data in transit. The system may be scalable to handle high transaction volumes, leveraging technologies such as distributed computing and load balancing.

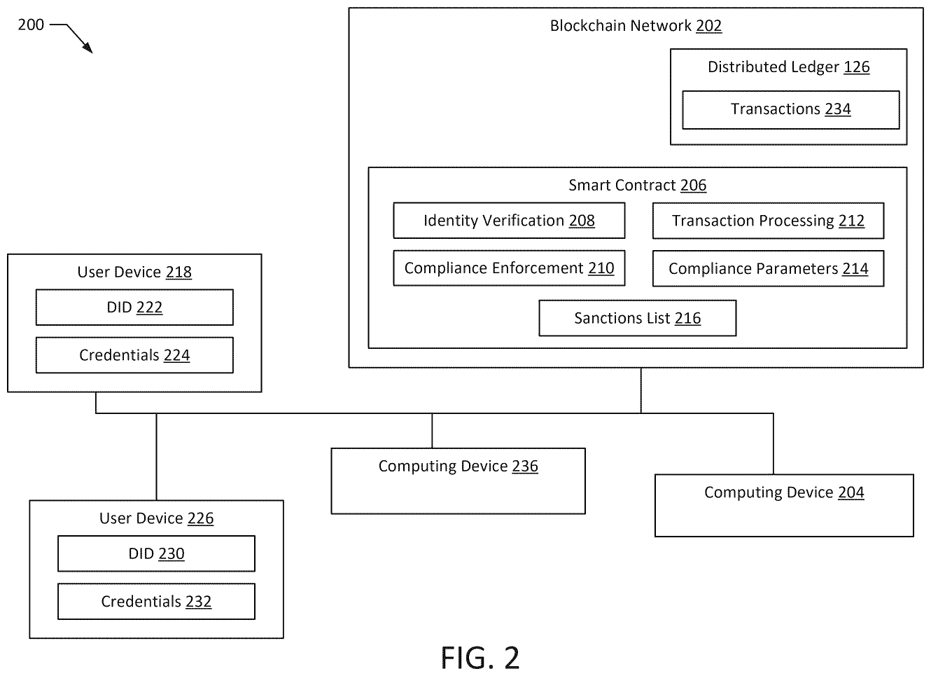

FIG. 2 depicts a system 200 for smart contract management and transaction processing on a blockchain network 202 according to one aspect of the present disclosure. The system 200 includes a blockchain network 202, a computing device 204 that deploys a smart contract 206, user devices 218 and 226 associated with users A and B respectively, transactions 234, and a privacy agent computing device 236.

The blockchain network 202 may be any suitable distributed ledger technology platform that supports smart contracts and decentralized applications. Examples include Ethereum, Hyperledger Fabric, or other blockchain platforms that allow for programmable transaction logic and consensus mechanisms. The blockchain network 202 incorporates the distributed ledger 126, which maintains an immutable record of all transactions and smart contract executions within the system 200. The computing device 204 deploys the smart contract 206 on the blockchain network 202. This computing device may be a server computer, a cluster of servers, or cloud-based computing resources operated by an entity responsible for managing the smart contract 206.

The smart contract 206 may be implemented as self-executing piece of code configured to manage transactions involving users based on decentralized identifiers (DIDs) and associated verifiable credentials. The smart contract may include one or more modules, which may be implemented as instructions or code. The modules may include an identity verification module 208, a compliance enforcement module 210, and a transaction processing module 212. The identity verification module 208 interfaces with distributed identity mechanisms to verify DIDs 222, 230 and associated verifiable credentials 224, 232 of users involved in transactions. It accesses DID documents and validates verifiable credentials within the smart contract logic, ensuring that users are authenticated and authorized to engage in transactions. In particular implementations, the identity verification module 208 may be configured to ensure that only users with valid DIDs issued by authorized issuers can access the privacy-enhancing features of the system, thereby enabling permissioned privacy.

The compliance enforcement module 210 enforces compliance rules for transactions based on verified identity attributes. Utilizing compliance parameters 214 and checking against sanction lists 216, the module 210 determines whether transactions meet regulatory requirements. This module applies rules that may limit transaction amounts, frequencies, or prohibit transactions with sanctioned entities, thereby adhering to legal and regulatory standards, as further discussed herein.

The transaction processing module 212 handles the execution of transactions 234 involving digital currency transfers between users based on their DIDs. It executes transactions upon successful verification and compliance checks, updating account balances associated with users'DIDs. The smart contract 206 may store compliance parameters 214 and sanction lists 216 as part of its state or access them through mechanisms provided by the blockchain network 202.

User devices 218 and 226 are associated with users A and B, respectively. These devices may be smartphones, tablets, laptops, or other computing devices through which users interact with the system 200. Each user device manages the user's decentralized identifier and verifiable credentials. User Device 218 is associated with user A, managing DID 222 and verifiable credentials 224. User Device 226 is associated with user B, managing DID 230 and verifiable credentials 232. Users interact with the smart contract 206 via their respective user devices to initiate transactions. The user devices 218, 226 may implement one or more wallet applications or decentralized applications (dApps) that handle identity management, credential storage, transaction creation, and communication with the blockchain network 202.

The privacy agent computing device 236 may be utilized to facilitate privacy-enhanced transactions on behalf of users. It performs functions such as submitting transactions to the blockchain network 202, verifying privacy proofs, and handling transaction fees. Acting as an intermediary, the privacy agent computing device 236 enhances user privacy while interacting with the smart contract 206, ensuring that sensitive information is protected throughout the transaction process.

The method involves several steps to achieve secure and compliant transaction processing. Initially, the computing device 204 deploys the smart contract 206 on the blockchain network 202. The smart contract is configured to verify decentralized identifiers and associated verifiable credentials by accessing DID documents and validating credentials of users involved in transactions. This involves retrieving DID documents from the distributed ledger 126, parsing identity attributes, and verifying digital signatures using public keys associated with the DIDs.

Moreover, the smart contract enforces compliance rules based on verified identity attributes. The compliance enforcement module 210 uses compliance parameters 214, such as transaction limits and verification statuses, and checks against sanction lists 216 to ensure transactions comply with regulatory requirements. It applies rules that may limit transaction amounts, frequencies, or prohibit transactions with sanctioned entities.

The smart contract also processes transactions based on DIDs. The transaction processing module 212 executes digital currency transfers between users by updating account balances associated with their DIDs upon successful verification and compliance checks. This ensures that transactions are accurately recorded and that the integrity of the ledger is maintained.

Users interact with the smart contract through their devices. User devices 218 and 226 initiate transactions by generating transaction requests through their wallet applications. These requests include details, such as the recipient's DID, transaction amount, and any required privacy proofs. Transactions may be standard or privacy-enhanced. For privacy-enhanced transactions, user devices 218, 226 may generate zero-knowledge proofs or other cryptographic proofs to conceal sensitive information, enhancing privacy and security.

User devices submit transactions to the blockchain network 202, potentially via a privacy agent computing device 236, which assists in managing transaction fees and enhancing privacy. The privacy agent plays a pivotal role in ensuring that transaction origins are obscured, contributing to user anonymity on the network.

The smart contract 206 executes transactions upon successful verification and compliance checks. The identity verification module 208 verifies the DIDs and verifiable credentials provided, confirming the authenticity of credentials through digital signature verification and checking validity periods. The compliance enforcement module 210 enforces compliance rules by determining transaction limits based on verified identity attributes and checking sanction lists 216 to ensure neither party is a sanctioned entity.

If verification and compliance checks pass, the transaction processing module 212 updates the ledger to reflect the digital currency transfer between users. For privacy-enhanced transactions, the module processes transactions without revealing sensitive details, maintaining anonymized state updates and preserving user confidentiality.

Additional details of the system's components further illustrate the comprehensive nature of the solution. The identity verification module 208 interfaces with the distributed identity module to access DID documents and validate verifiable credentials. This involves accessing DID documents stored on the distributed ledger 126 to retrieve public keys and service endpoints, validating verifiable credentials by checking digital signatures against issuer public keys, and ensuring credentials are not expired or revoked and that they meet the required assurance levels. In this way, for privacy-enhanced transactions, the module processes transactions without revealing sensitive details, maintaining anonymized state updates and preserving user confidentiality by requiring verified identities through DIDs.

The compliance enforcement module 210 enforces compliance rules by determining permissible transaction amounts based on user verification levels. For example, users with basic verification may have lower limits than those with enhanced verification, reflecting the varying levels of trust and risk associated with different user profiles. The module performs sanction list checks by comparing user DIDs against sanction lists 216 obtained from regulatory authorities. Sanction lists are updated dynamically by retrieving data from trusted sources and integrating updates into the smart contract's checks, ensuring that the system remains compliant with current regulations. In particular, in certain implementations, sanctions checks are performed on public blockchain transactions by referencing an on-chain oracle or sanctions list to verify that neither the sender nor the recipient's address is sanctioned. Additionally or alternatively, DID-issuing entities may perform sanctions checks against known lists before issuing, updating, or permitting transactions to be created by DIDs. In particular implementations, a DID issuer may revoke a DID if a user is added to a sanctions list after having a DID issued. This revocation may be recorded on-chain, immediately preventing the use of the DID for future transactions.

Transaction prohibition is enforced by rejecting transactions that exceed limits or involve sanctioned entities. Users are notified of rejection reasons via their user devices, providing transparency and guidance on any necessary corrective actions.

The transaction processing module 212 handles the execution of transactions by transferring tokens between user accounts associated with their DIDs. The tokens may adhere to blockchain-specific standards like ERC-20 for fungible tokens, facilitating compatibility and interoperability within the blockchain ecosystem. The module executes privacy-enhanced transactions that use zero-knowledge proofs or other privacy methods to conceal amounts and participant identities on the public ledger. Atomicity and security are ensured by processing transactions atomically to prevent partial execution and utilizing blockchain security features to protect against attacks, maintaining the integrity and reliability of the system.

The privacy agent computing device 236 enhances user privacy by submitting transactions on behalf of users to the blockchain network 202, obscuring the origin of the transaction. It may verify the validity of privacy proofs before submission to prevent fraudulent activities and handles transaction fees (gas fees), which may be subsidized or managed to optimize costs. Strategies such as batching transactions or using Layer 2 solutions may be employed (e.g., to improve efficiency and reduce expenses). In certain implementations, the computing device 236 may be associated with a financial institutions. In certain implementations, the computing device 236 may be an exemplary implementation of the computing device 104, 120, or combinations thereof.

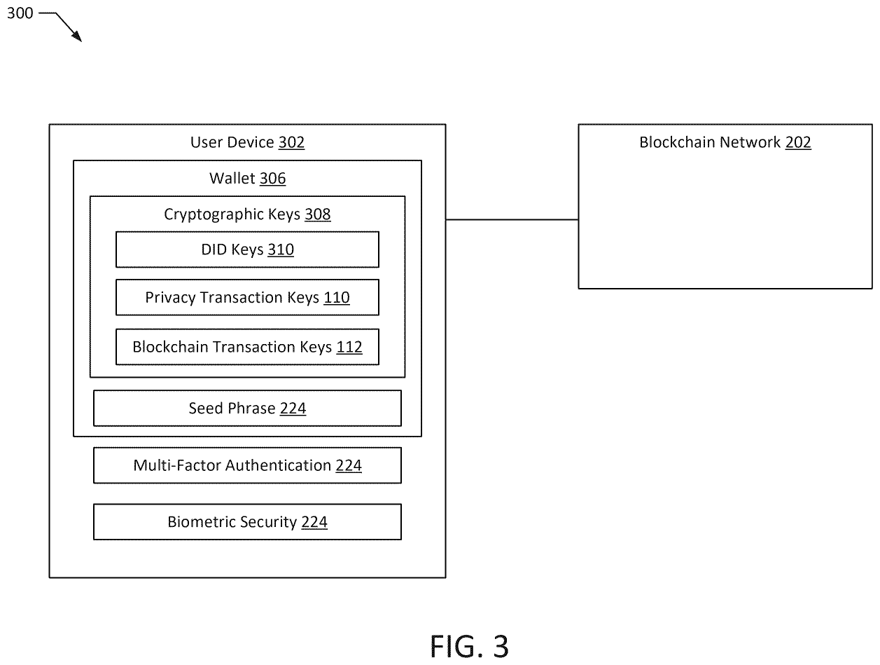

FIG. 3 illustrates a system 300 for managing user wallets and key integration on a user device 302 associated with a user 304. This system enables the user device 302 to generate a digital wallet 306 that manages cryptographic keys for decentralized identity (DID), privacy-enhancing transactions, and blockchain transactions. The digital wallet 306 is linked to the user's DID and allows the user 304 to perform transactions on a blockchain network 202 while maintaining security and privacy.

### Generation of the Digital Wallet

The user device 302 generates the digital wallet 306 associated with the user 304. The digital wallet 306 is configured to manage cryptographic keys 308 required for various functionalities, including DID management, privacy-enhancing transactions, and standard blockchain transactions. Upon initiating the wallet application on the user device 302, the user 304 is guided through the setup process, which may include creating a wallet, such as a hierarchical deterministic (HD) wallet.

The wallet may generate, receive, or otherwise determine multiple cryptographic keys from a single seed phrase 316, such as according to standards like BIP32 and BIP44. A seed phrase 316, such as a mnemonic seed phrase (e.g., a multi-wordphrase generated according to the BIP39 standard) may serve as the foundation of the wallet's security and acts as the root from which all cryptographic keys are derived. For example, the seed phrase 316 might be “correct horse red cottage . . . ”.

The digital wallet 306 manages various cryptographic keys 308, each tailored for specific functions within the system. The DID management keys 310 are used for creating, updating, and controlling the user's decentralized identifier (DID), ensuring secure identity operations in compliance with the W3C Decentralized Identifiers (DID) standards. The privacy transaction keys 312 are specialized keys utilized for generating cryptographic proofs in privacy-enhancing transactions, such as zero-knowledge proofs, enabling the user to conduct confidential transactions on the blockchain network 202. Additionally, the blockchain transaction keys 314 are designated for signing standard transactions on the blockchain network 202, such as transfers of digital assets or tokens. Separating these keys from identity keys enhances security and reduces the risk of linking identity with transaction activities.

To protect access to the digital wallet 306 and the cryptographic keys 308, the user device 302 employs multi-factor authentication (MFA) through a multi-factor authentication module 318. The MFA may include a combination of something the user knows (such as a password or PIN), something the user has (like the device itself), and something the user is (biometric data). Biometric security is further enhanced by a biometric security module 320, which may utilize device capabilities such as fingerprint scanners or facial recognition hardware to authenticate the user 304. Private keys associated with the cryptographic keys 308 are encrypted and stored securely within the user device 302. Secure key storage may utilize hardware-backed security features such as Trusted Execution Environments (TEE) or Secure Enclaves, employing strong encryption algorithms like AES-256 to protect data at rest.

### Linking the Digital Wallet to the User's DID

The user device 302 links the digital wallet 306 to the user's DID, establishing a connection between the user's identity and their wallet functionalities. This process involves creating or importing a DID that serves as a unique identifier conforming to the W3C DID specification. The digital wallet 306 assists the user 304 in generating a new DID or importing an existing one, associating the DID management keys 310 with the DID for identity management operations such as updating or revoking the DID document. This DID document contains the DID and associated public keys and may include metadata, authentication methods, and service endpoints relevant to the user's identity.

By separating cryptographic keys within the digital wallet 306 for different functionalities—identity management, transaction signing, and generating privacy proofs—the system enhances security and user control. Key separation reduces risk by isolating keys so that if one key is compromised, others remain secure. The wallet uses distinct derivation paths for each key type, following hierarchical deterministic practices. The digital wallet 306 may automate key rotation processes and update the DID document accordingly. Periodic key rotation enhances security by changing keys at regular intervals, and users can revoke compromised keys through the wallet, which interfaces with revocation registries on the distributed ledger 126.

### Performing Transactions on the Blockchain Network

The user device 302 performs transactions on the blockchain network 202 using the digital wallet 306 while maintaining security and privacy. The blockchain network 202 may be any suitable distributed ledger technology platform that supports smart contracts and decentralized applications, such as Ethereum or Hyperledger Fabric. Users interact with the wallet application on the user device 302 to initiate transactions, with the wallet interface designed to be intuitive and user-friendly, guiding users through the process of creating transaction requests. In certain implementations, when initiating a transaction, a user's digital currency is sent to the smart contract, which holds the digital currency and credits the user's a balance in a second current or digital asset (such as a internal privacy token balance). Subsequent private transfers adjust balances within the smart contract's internal ledger without exposing transaction details on the public blockchain. In such instances, the digital wallet 306 may be configured to construct the transaction such that tokens are not directly or actually transferred. Instead, the smart contract may be configured to update the internal ledger to debit the sender's privacy token balance and credit the recipient's balance.

When initiating a transaction, the user 304 inputs necessary details such as the recipient's address or DID and the amount to be transferred. The digital wallet 306 constructs the transaction, incorporating any optional data or messages. Before submitting the transaction, the wallet automatically enforces transaction limits and compliance checks by verifying the user's compliance status based on the associated DID and verifiable credentials. This includes checking transaction amounts against predefined transaction limits associated with the user's verified identity attributes and preventing transactions that exceed these limits or violate compliance requirements. For example, if the user 304 has a transaction limit of $10,000 per day based on their compliance status, the wallet may prevent any transaction that exceeds this amount. Compliance checks may also involve ensuring that the recipient is not on any sanction list or flagged due to regulatory concerns.

The digital wallet 306 uses the appropriate cryptographic keys to sign transactions. For standard transactions, the blockchain transaction keys 314 are used, while for privacy-enhanced transactions, the privacy transaction keys 312 generate cryptographic proofs such as zero-knowledge proofs, enabling transaction validation without revealing sensitive details. Privacy-enhancing techniques may also include ring signatures or the use of anonymity sets to obscure transaction patterns.

The user device 302 may interface with a privacy agent computing device (similar to the privacy agent computing device 236 in FIG. 2) for privacy-enhanced transactions. The privacy agent submits transactions on behalf of the user, handles transaction fees (gas fees), and adds an additional layer of anonymity by obscuring the origin of the transaction.

The digital wallet 306 supports may support multiple currencies, enabling the user 304 to manage different central bank digital currencies (CBDCs) or cryptocurrencies within a unified interface. Users can view balances, transact across currencies, and access real-time exchange rates for conversions, enhancing the wallet's versatility and user convenience.

Notifications and real-time updates may be provided by the digital wallet 306 to inform the user 304 of transaction statuses and regulatory compliance. For example, users may receive updates on pending transactions, confirmations, or any failures, along with compliance-related alerts.

### Other Features

The digital wallet 306 includes recovery mechanisms that allow the user 304 to restore the wallet, e.g., using the seed phrase 316, a secure cloud backup, or combinations thereof. Seed phrase recovery involves inputting the seed phrase into the wallet application on a new device, which regenerates all keys and addresses based on the seed. Secure cloud backup may be a feature where the wallet offers encrypted backups to secure cloud services.

Integration with banking systems and other computing devices may be facilitated through APIs, middleware, and the like. The wallet 306 may be configured to comply with various industry standards and protocols, such as ISO 20022 for financial messaging, ensuring compatibility with other systems and services.

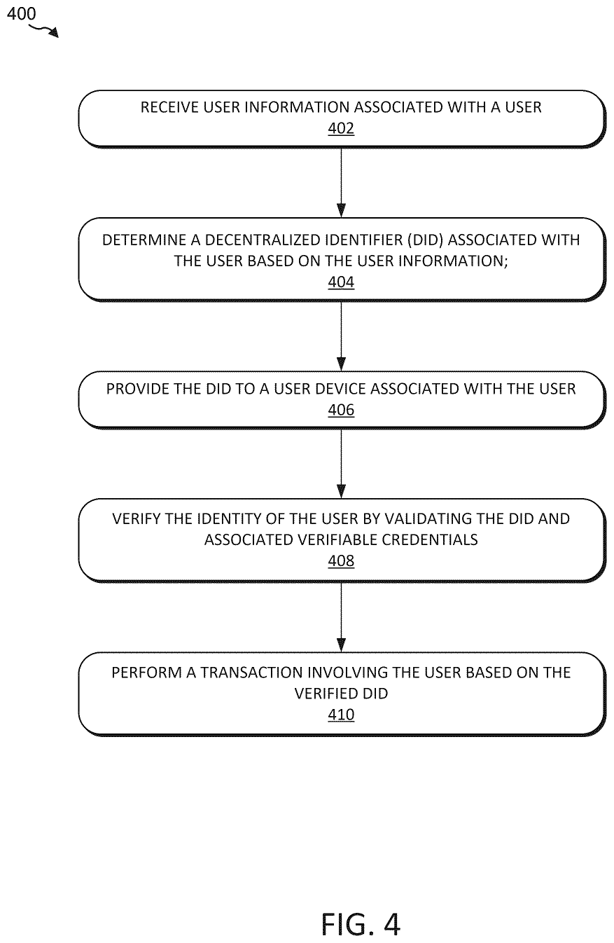

FIGS. 4-6 depict methods 400, 500, 600 according to exemplary aspects of the present disclosure. Starting with FIG. 4, the method 400 may be implemented on a computer system, such as the system 100. For example, the method 400 may be implemented by the computing devices 102, 104, 106. The method 400 may also be implemented by a set of instructions stored on a computer-readable medium that, when executed by a processor, cause the computing device to perform the method 400. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks may be optional.

At block 402, the method 400 includes receiving, by a first computing device, user information associated with a user. For example, the first computing device 102 may receive user information 108 associated with a user. In certain implementations, the user information may include identification documents provided in compliance with Know Your Customer (KYC) requirements. The user information 108 may include personal details such as the user's name, address, date of birth, government-issued identification numbers, and biometric data. The first computing device 102 may receive this information through secure communication channels from a user device 106 associated with the user.

At block 404, the method 400 includes determining, by the first computing device, a decentralized identifier (DID) associated with the user based on the user information. For example, the first computing device 102 may determine a DID 112 associated with the user based on the user information 108. Determining the DID may include generating a public-private key pair for the user, associating the DID with the public key of the public-private key pair, and creating a DID document containing the DID and the public key. In certain implementations, the DID may be issued by an authorized and regulated entity selected from the group consisting of financial institutions, government agencies, or other regulated bodies. In certain implementations, the first computing device 102 may process the user information 108 to generate verifiable credentials containing identity attributes of the user. The verifiable credentials may be associated with the DID 112 and may be digitally signed using a private key of an issuing entity.

At block 406, the method 400 includes providing, by the first computing device, the DID to a user device associated with the user. For example, the first computing device 102 may provide the DID 112 to the user device 106 associated with the user. In certain implementations, the DID document containing the DID 112 and public key may be stored on a distributed ledger 126 accessible to authorized entities. The user device 106 may receive the DID 112 and associated verifiable credentials 118 securely from the first computing device 102.

At block 408, the method 400 includes verifying, by a second computing device, the identity of the user by validating the DID and associated verifiable credentials. For example, the second computing device 104 may verify the identity of the user by validating the DID 112 and associated verifiable credentials 118. Verifying the identity of the user may include receiving, by the second computing device 104, the verifiable credentials associated with the DID 112, validating the verifiable credentials using cryptographic signatures associated with the issuing entity, and determining whether the user meets predefined compliance requirements based on the identity attributes in the verifiable credentials.

At block 410, the method 400 includes performing, by a third computing device, a transaction involving the user based on the verified DID. For example, the third computing device 120 may perform a transaction 122 involving the user based on the verified DID 112. Performing the transaction may include the smart contract receiving a transaction that transfers a first amount of a first digital asset (e.g., digital currency) from the user device 106. The smart contract may hold the digital currency and credit an internal ledger with a second amount of a second digital asset (e.g., a privacy token) associated with the user's DID, where the second amount is determined based on the first amount. The smart contract may update balances in the internal ledger to reflect transactions involving the privacy tokens without transferring actual tokens to user devices. When the user initiates a subsequent transaction, the smart contract may debit the user's balance of the privacy token in the internal ledger and credit a recipient's balance in the internal ledger based on encrypted instructions or zero-knowledge proofs provided by the user. Prior to executing the transaction, the smart contract may verify compliance with regulatory rules. Verifying compliance may include determining whether the transaction exceeds predefined transaction limits associated with the user's verified identity attributes and rejecting the transaction if it exceeds the transaction limits.

In certain implementations, enforcing regulatory compliance may involve the second computing device 104 applying transaction limits based on the user's verified identity attributes and compliance requirements. This may include checking the DID 112 against updated sanction lists obtained from authorized sources and preventing the user from performing transactions upon determining that the user is identified as a sanctioned user.

Additionally, the computing devices 102, 104, 120 may monitor transactions for suspicious activities using automated systems. Monitoring transactions may include detecting patterns indicative of money laundering or fraud through analytics or machine learning algorithms. Upon detecting suspicious activities, the system may report flagged transactions to regulatory authorities in compliance with legal obligations while maintaining user privacy.

Furthermore, the computing devices may facilitate privacy-preserving audits by authorized entities without disclosing sensitive user data. Facilitating privacy-preserving audits may include providing zero-knowledge proofs to auditors to verify compliance without accessing underlying transaction details. The system may maintain immutable audit logs of transactions and compliance checks in a secure ledger accessible to authorized personnel.

In certain implementations, the user device 106 may update the DID 112 or associated verifiable credentials 118 in response to changes in the user's identity information 108 or compliance status. This ensures that the user's information remains current and compliant with regulatory requirements.

Moreover, the transaction performed by the third computing device 120 may involve converting digital currency to fiat currency through authorized channels while maintaining user privacy. The system may securely interface with financial institutions to facilitate such conversions without compromising the confidentiality of the user's transaction details.

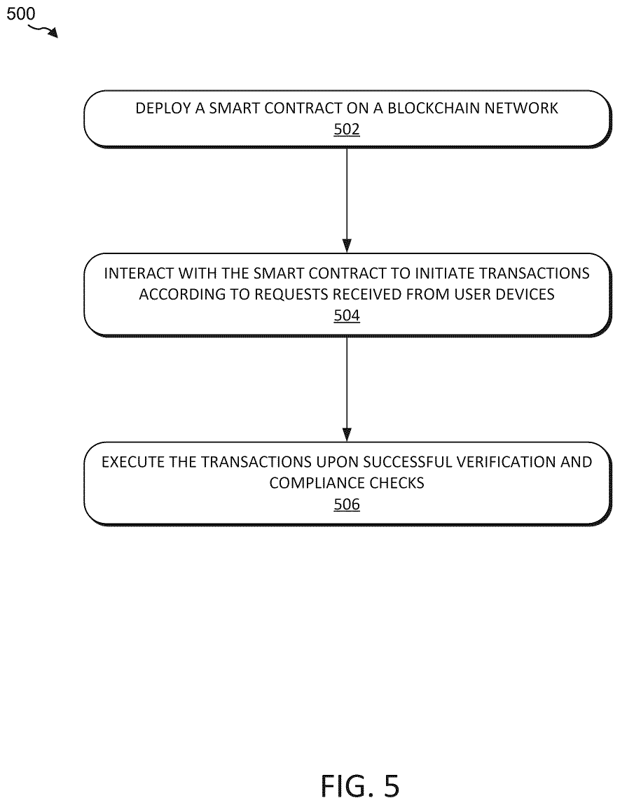

Turning now to FIG. 5, the method 500 may be implemented on a computer system, such as the system 200. For example, the method 500 may be implemented by the computing devices 204, 218, 226, and the smart contract 206. The method 500 may also be implemented by a set of instructions stored on a computer-readable medium that, when executed by a processor, cause the computing device to perform the method 500. Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks may be optional.

At block 502, the method 500 includes deploying, by a computing device, a smart contract on a blockchain network, the smart contract configured to verify decentralized identifiers (DIDs) and associated verifiable credentials of users involved in transactions, enforce compliance rules for transactions based on verified identity attributes, and process transactions involving digital currency transfers between users based on their DIDs. For example, the computing device 204 may deploy a smart contract 206 on the blockchain network 202. In certain implementations, the smart contract 206 may include an identity verification module 208 interfacing with a distributed identity module to access DID documents and validate verifiable credentials. The smart contract 206 may be configured to enforce compliance rules by determining transaction limits for users based on their verified identity attributes and rejecting transactions that exceed the determined transaction limits. Additionally, the smart contract 206 may be configured to check transactions against sanction lists obtained from authorized sources that are regularly updated, determine whether any party involved in the transaction is identified as a sanctioned entity, and reject the transaction if it involves a sanctioned entity.

At block 504, the method 500 includes interacting with the smart contract to initiate transactions. For example, user devices 218 and 226 associated with users A and B may interact with the smart contract 206 to initiate transactions. Interacting with the smart contract may include the user devices sending transactions that transfer first amounts of a first digital asset to the smart contract. The smart contract may hold the digital currency and credit internal ledgers with corresponding second amounts of a second digital asset (privacy tokens) associated with the users'DIDs. The user devices may submit encrypted instructions or zero-knowledge proofs to perform transactions involving the privacy tokens within the internal ledger, without transferring actual tokens to user devices.

At block 506, the method 500 includes executing, by the smart contract, the transactions upon successful verification and compliance checks. For example, the smart contract 206 may execute the transactions upon successful verification of the users'DIDs and verifiable credentials, and after enforcing compliance rules based on verified identity attributes. Executing the transactions may involve debiting the sender's balance of the privacy token in the internal ledger and crediting the recipient's balance in the internal ledger based on the provided encrypted instructions or zero-knowledge proofs. The smart contract may maintain the internal ledger to prevent double-spending and ensure transaction integrity using cryptographic proofs. In certain implementations, executing transactions may involve transferring digital currency tokens between user accounts on the blockchain network 202 upon successful verification. The smart contract 206 may process the privacy-enhanced transactions without revealing the users'identities or transaction details. The smart contract 206 may verify zero-knowledge proofs provided by the users without accessing sensitive transaction data, and maintain anonymized state updates on the blockchain network 202 to preserve transaction privacy.

In certain implementations, the smart contract 206 may facilitate privacy-preserving audits by authorized entities without disclosing sensitive user data. Facilitating privacy-preserving audits may include generating cryptographic proofs, such as zero-knowledge proofs, that demonstrate compliance with regulatory requirements, and providing the cryptographic proofs to authorized auditors to verify transaction compliance without revealing transaction details.

Furthermore, the smart contract 206 may handle transaction fees associated with processing transactions on the blockchain network 202, potentially through the privacy agent computing device 236 that submits transactions on behalf of users. The privacy agent computing device 236 may verify the validity of the privacy proofs before submitting the transactions to the blockchain network 202 and handle transaction fees associated with submitting the transactions.

Additionally, the smart contract 206 may enforce predefined transaction limits for privacy-enhanced transactions based on the users'verified identity attributes. The smart contract 206 may be developed using a programming language compatible with the blockchain network 202. Compliance parameters within the smart contract 206 may be updated through authorized administrative functions in response to changes in regulatory requirements.

Moreover, the method 500 includes authenticating, by the smart contract 206 or associated systems, the privacy agent computing device 236 and user devices 218, 226 using secure communication protocols prior to transaction submission. The smart contract 206 may record transaction details in an immutable ledger while preserving user anonymity through cryptographic techniques.

In certain implementations, the sanction lists may be updated dynamically by retrieving updated sanction lists from regulatory authorities or trusted data feeds and integrating the updated lists into the smart contract's compliance checks. Determining whether the transaction is prohibited may include analyzing the DIDs of parties involved in the transaction, comparing the DIDs against the sanction lists, and flagging the transaction if a match is found.

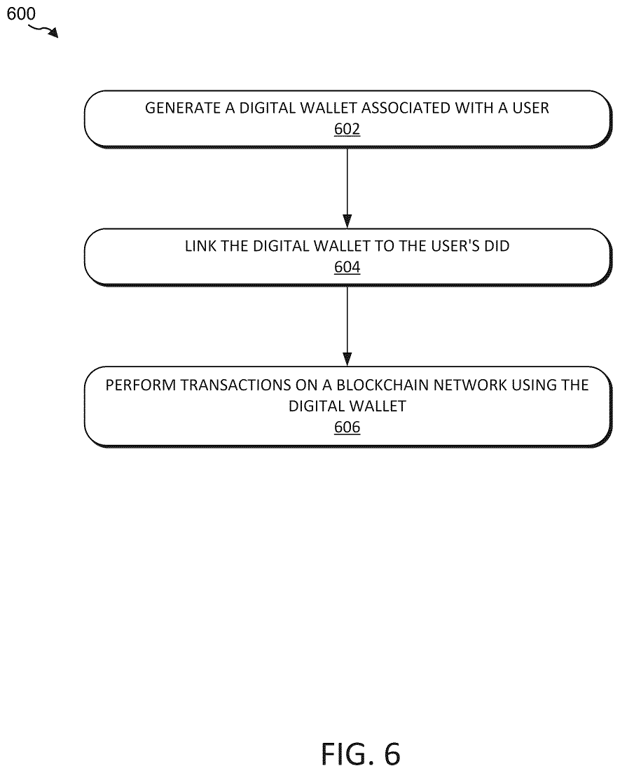

Turning now to FIG. 6, the method 600 may be implemented on a computer system, such as the system 300. For example, the method 600 may be implemented by the user device 302. The method 600 may also be implemented by a set of instructions stored on a computer-readable medium that, when executed by a processor, cause the computing device to perform the method 600. Although the examples below are described with reference to the flowchart illustrated in FIG. 6, many other methods of performing the acts associated with FIG. 6 may be used. For example, the order of some of the blocks may be changed, certain blocks may be combined with other blocks, one or more of the blocks may be repeated, and some of the blocks may be optional.

At block 602, the method 600 includes generating, by a user device, a digital wallet associated with a user, the digital wallet configured to manage cryptographic keys for decentralized identity (DID), privacy-enhancing transactions, and blockchain transactions. For example, the user device 302 may generate a digital wallet 306 associated with a user 304, where the digital wallet 306 is configured to manage cryptographic keys 308 for decentralized identity (DID), privacy-enhancing transactions, and blockchain transactions. In certain implementations, generating the digital wallet may include generating a hierarchical deterministic (HD) wallet that generates multiple cryptographic keys from a single seed. In such cases, the seed may be derived from a mnemonic seed phrase provided by the user 304. Additionally, the user device 302 may secure the digital wallet 306 with multi-factor authentication and biometric security measures within the user device 302. The user device 302 may provide a recovery mechanism for the digital wallet 306 using the mnemonic seed phrase. The user 304 can restore the digital wallet 306 on a new device using the seed phrase or a secure cloud backup.

At block 604, the method 600 includes linking, by the user device, the digital wallet to the user's DID. For example, the user device 302 may link the digital wallet 306 to the user's DID 112. In certain implementations, the user device 302 may separate cryptographic keys within the digital wallet 306 for different functionalities, including identity management, transaction signing, and generating privacy proofs. This separation enhances security by isolating keys used for different purposes.

At block 606, the method 600 includes performing, by the user device, transactions on a blockchain network using the digital wallet. For example, the user device 302 may perform transactions on the blockchain network 202 using the digital wallet 306 while maintaining security and privacy. Performing the transactions may include the user device sending transactions that transfer first amounts of a first digital asset to a smart contract deployed on the blockchain network. The smart contract may hold the digital currency and credit an internal ledger with corresponding second amounts of a second digital asset (privacy tokens) associated with the user's DID. The user device may initiate subsequent transactions by submitting encrypted instructions or zero-knowledge proofs to the smart contract, which may debit the user's balance of the privacy token in the internal ledger and credit the recipient's balance in the internal ledger. In certain implementations, the user device 302 may automatically enforce transaction limits and compliance checks before performing transactions by verifying the user's compliance status based on the associated DID 112 and verifiable credentials 118, checking transaction amounts against predefined transaction limits associated with the user's verified identity attributes, and preventing transactions that exceed the transaction limits or violate compliance requirements. Additionally, the user device 302 may monitor transactions for suspicious activities using analytics or machine learning algorithms and alert the user 304 to potential security concerns upon detecting suspicious activities.

Furthermore, the digital wallet 306 may support multiple currencies, enabling the user 304 to manage different digital currencies or cryptocurrencies. The user device 302 may provide notifications and real-time updates on transaction statuses and regulatory compliance checks. The user device 302 may update software components of the digital wallet 306 automatically to maintain compatibility and security with the blockchain network 202 and compliance with regulatory requirements.

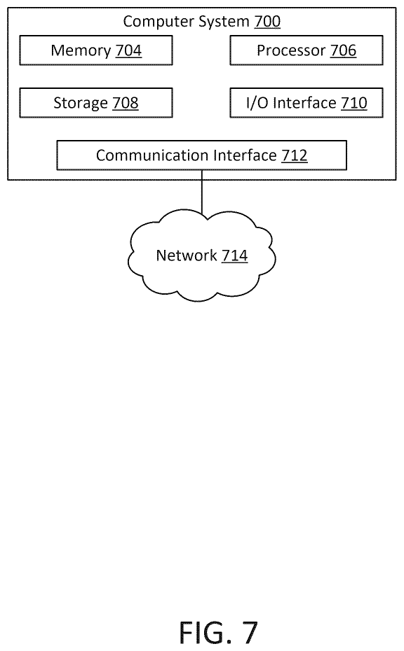

FIG. 7 illustrates an example computer system 700 that may be utilized to implement one or more of the devices and/or components discussed herein, such as the first computing device 102, second computing device 104, third computing device 120, computing device 204, user devices 106, 218, 226, user device 302, privacy agent computing device 236, digital wallet 306, and any components associated with systems 100, 200, and 300. In particular embodiments, one or more computer systems 700 perform one or more steps of one or more methods described or illustrated herein. In particular embodiments, one or more computer systems 700 provide the functionalities described or illustrated herein. In particular embodiments, software running on one or more computer systems 700 performs one or more steps of one or more methods described or illustrated herein or provides the functionalities described or illustrated herein. Particular embodiments include one or more portions of one or more computer systems 700. Herein, a reference to a computer system may encompass a computing device, and vice versa, where appropriate. Moreover, a reference to a computer system may encompass one or more computer systems, where appropriate.

This disclosure contemplates any suitable number of computer systems 700. This disclosure contemplates the computer system 700 taking any suitable physical form. As an example and not by way of limitation, the computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, a mobile device such as a smartphone or tablet (e.g., user devices 106, 218, 226, 302), an interactive kiosk, a mainframe, a mesh of computer systems, a hardware wallet, a privacy agent computing device, a server computer (e.g., computing devices 102, 104, 204), a personal digital assistant (PDA), blockchain nodes, distributed ledger technology platforms, an augmented/virtual reality device, or a combination of two or more of these. Where appropriate, the computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 706, memory 704, storage 708, an input/output (I/O) interface 710, secure key storage module 716, cryptographic hardware module 718, and a communication interface 712. In certain implementations, the computer system 700 may include a Trusted Execution Environment (TEE) or Secure Enclave for enhanced security in cryptographic operations. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 706 includes hardware for executing instructions, such as those making up a computer program. As an example and not by way of limitation, to execute instructions, the processor 706 may retrieve (or fetch) the instructions from an internal register, an internal cache, memory 704, or storage 708; decode and execute the instructions; and then write one or more results to an internal register, internal cache, memory 704, or storage 708. In particular embodiments, the processor 706 may include one or more internal caches for data, instructions, or addresses. This disclosure contemplates the processor 706 including any suitable number of any suitable internal caches, where appropriate. As an example and not by way of limitation, the processor 706 may include one or more instruction caches, one or more data caches, and one or more translation lookaside buffers (TLBs). Instructions in the instruction caches may be copies of instructions in memory 704 or storage 708, and the instruction caches may speed up retrieval of those instructions by the processor 706. Data in the data caches may be copies of data in memory 704 or storage 708 that are to be operated on by computer instructions; the results of previous instructions executed by the processor 706 that are accessible to subsequent instructions or for writing to memory 704 or storage 708; or any other suitable data. The data caches may speed up read or write operations by the processor 706. The TLBs may speed up virtual-address translation for the processor 706. In particular embodiments, processor 706 may include one or more internal registers for data, instructions, or addresses. This disclosure contemplates the processor 706 including any suitable number of any suitable internal registers, where appropriate. Where appropriate, the processor 706 may include one or more arithmetic logic units (ALUs), be a multi-core processor, or include one or more processors 706. In certain implementations, the processor 706 may be specifically designed or configured to perform cryptographic operations, such as generating public-private key pairs, performing digital signature verification, and processing zero-knowledge proofs for privacy-enhancing transactions. Although this disclosure describes and illustrates a particular processor, this disclosure contemplates any suitable processor.

In particular embodiments, the memory 704 includes main memory for storing instructions for the processor 706 to execute or data for processor 706 to operate on. As an example, and not by way of limitation, computer system 700 may load instructions from storage 708 or another source (such as another computer system 700) to the memory 704. The processor 706 may then load the instructions from the memory 704 to an internal register or internal cache. To execute the instructions, the processor 706 may retrieve the instructions from the internal register or internal cache and decode them. During or after execution of the instructions, the processor 706 may write one or more results (which may be intermediate or final results) to the internal register or internal cache. The processor 706 may then write one or more of those results to the memory 704. In particular embodiments, the processor 706 executes only instructions in one or more internal registers or internal caches or in memory 704 (as opposed to storage 708 or elsewhere) and operates only on data in one or more internal registers or internal caches or in memory 704 (as opposed to storage 708 or elsewhere). One or more memory buses (which may each include an address bus and a data bus) may couple the processor 706 to the memory 704. The bus may include one or more memory buses, as described in further detail below. In particular embodiments, one or more memory management units (MMUs) reside between the processor 706 and memory 704 and facilitate accesses to the memory 704 requested by the processor 706. In particular embodiments, the memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. In certain implementations, the memory 704 may store cryptographic keys, DID documents, verifiable credentials, transaction data, compliance parameters, and sanction lists required for the functionalities described herein.

In particular embodiments, the storage 708 includes mass storage for data or instructions. As an example and not by way of limitation, the storage 708 may include a hard disk drive (HDD), a floppy disk drive, flash memory, an optical disc, a solid-state drive (SSD), a magneto-optical disc, magnetic tape, or a Universal Serial Bus (USB) drive or a combination of two or more of these. The storage 708 may include removable or non-removable (or fixed) media, where appropriate. The storage 708 may be internal or external to computer system 700, where appropriate. In particular embodiments, the storage 708 is non-volatile, solid-state memory. In particular embodiments, the storage 708 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 708 taking any suitable physical form. The storage 708 may include one or more storage control units facilitating communication between processor 706 and storage 708, where appropriate. Where appropriate, the storage 708 may include one or more storages 708. Although this disclosure describes and illustrates particular storage, this disclosure contemplates any suitable storage. In certain implementations, the storage 708 may store blockchain data, distributed ledger records, smart contracts, and audit logs to maintain transaction integrity and compliance records.

In particular embodiments, the I/O Interface 710 includes hardware, software, or both, providing one or more interfaces for communication between computer system 700 and one or more I/O devices. The computer system 700 may include one or more of these I/O devices, where appropriate. One or more of these I/O devices may enable communication between a person (i.e., a user) and computer system 700. As an example and not by way of limitation, an I/O device may include a keyboard, keypad, microphone, touchscreen display, monitor, screen, display panel, mouse, printer, scanner, speaker, still camera, biometric sensors (such as fingerprint scanners or facial recognition cameras), stylus, tablet, touch screen, trackball, video camera, another suitable I/O device or a combination of two or more of these. An I/O device may include one or more sensors. Where appropriate, the I/O Interface 710 may include one or more device or software drivers enabling processor 706 to drive one or more of these I/O devices. The I/O interface 710 may include one or more I/O interfaces 710, where appropriate. Although this disclosure describes and illustrates a particular I/O interface, this disclosure contemplates any suitable I/O interface or combination of I/O interfaces.

In particular embodiments, communication interface 712 includes hardware, software, or both providing one or more interfaces for communication (such as, for example, packet-based communication) between computer system 700 and one or more other computer systems 700 or one or more networks 714. As an example and not by way of limitation, communication interface 712 may include a network interface controller (NIC) or network adapter for communicating with an Ethernet or any other wire-based network or a wireless NIC (WNIC) or wireless adapter for communicating with a wireless network, such as a Wi-Fi network. In certain implementations, communication interface 712 supports secure communication protocols, such as SSL/TLS, HTTPS, or secure messaging frameworks like DIDComm, to ensure secure transmission of sensitive data. This disclosure contemplates any suitable network 714 and any suitable communication interface 712 for the network 714. As an example and not by way of limitation, the network 714 may include one or more of an ad hoc network, a personal area network (PAN), a local area network (LAN), a wide area network (WAN), a metropolitan area network (MAN), the Internet, a blockchain network (e.g., blockchain network 202, 328), or a combination of two or more of these. One or more portions of one or more of these networks may be wired or wireless. As an example, computer system 700 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), a blockchain peer-to-peer network, or any other suitable wireless network or a combination of two or more of these. Computer system 700 may include any suitable communication interface 712 for any of these networks, where appropriate. Communication interface 712 may include one or more communication interfaces 712, where appropriate. Although this disclosure describes and illustrates a particular communication interface implementations, this disclosure contemplates any suitable communication interface implementation.

The computer system 700 may also include a bus 702. The bus 702 may include hardware, software, or both and may communicatively couple the components of the computer system 700 to each other. As an example and not by way of limitation, the bus 702 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), a Controller Area Network (CAN) bus, or another suitable bus or a combination of two or more of these buses. The bus may include one or more buses, where appropriate. Although this disclosure describes and illustrates a particular bus, this disclosure contemplates any suitable bus or interconnect.

In certain embodiments, the computer system 700 may include a secure key storage module 716. This module may be a hardware security module (HSM) or utilize trusted platform modules (TPMs) to securely store cryptographic keys used for DID management, transaction signing, and privacy-enhancing transactions. The secure key storage module 716 ensures that private keys are protected against unauthorized access and potential security breaches.

Furthermore, the computer system 700 may include a cryptographic hardware module 718 designed to accelerate cryptographic operations. This module may include dedicated cryptographic processors or accelerators that handle encryption, decryption, digital signature generation and verification, and zero-knowledge proof computations. By offloading these computationally intensive tasks, the cryptographic hardware module 718 enhances performance and efficiency, particularly important for user devices engaged in privacy-enhancing transactions or smart contract executions.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, solid-state drives (SSDs), floppy diskettes, floppy disk drives (FDDs), magnetic tapes, RAM-drives, SECURE DIGITAL cards or drives, flash memory devices, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving, by a first computing device, user information associated with a user;
determining, by the first computing device, a decentralized identifier (DID) associated with the user based on the user information;
providing, by the first computing device, the DID to a user device associated with the user;
verifying, by a second computing device, the identity of the user by validating the DID and associated verifiable credentials;
performing, by a third computing device, a transaction involving the user based on the verified DID.

2. The method of claim 1, wherein determining the DID comprises:
generating a public-private key pair for the user;
associating the DID with the public key of the public-private key pair;
creating a DID document containing the DID and the public key.

3. The method of claim 1, wherein determining the DID further comprises:
processing the user information to generate verifiable credentials containing identity attributes of the user;
associating the verifiable credentials with the DID;
digitally signing the verifiable credentials using a private key of an issuing entity.

4. The method of claim 2, further comprising storing the DID document on a distributed ledger accessible to authorized entities.

5. The method of claim 1, wherein verifying the identity of the user comprises:
receiving, by the second computing device, the verifiable credentials associated with the DID;
validating the verifiable credentials using cryptographic signatures associated with the issuing entity;
determining whether the user meets predefined compliance requirements based on the identity attributes in the verifiable credentials.

6. The method of claim 1, wherein performing the transaction comprises:
initiating, by the user device, a transaction request comprising the DID;
processing the transaction request through a smart contract deployed on a blockchain network.

7. The method of claim 1, wherein performing the transaction comprises converting digital currency to fiat currency while maintaining user privacy.

8. The method of claim 1, wherein performing the transaction comprises:
determining whether the transaction exceeds predefined transaction limits associated with the user's verified identity attributes;
rejecting the transaction upon determining that the transaction exceeds the transaction limits.

9. The method of claim 1, further comprising providing zero-knowledge proofs to auditors to verify compliance without accessing underlying transaction details.

10. The method of claim 1, wherein the user information comprises identification documents provided in compliance with Know Your Customer (KYC) requirements.

11. The method of claim 1, further comprising updating the DID or associated verifiable credentials in response to changes in the user's identity information or compliance status.

12. A system comprising:
a processor; and
a memory storing instructions which, when executed by the processor, cause the processor to perform operations including:
deploying a smart contract on a blockchain network, the smart contract configured to:
verify decentralized identifiers (DIDs) and associated verifiable credentials of users involved in transactions;
enforce compliance rules for transactions based on verified identity attributes; and
process transactions involving digital currency transfers between users based on associated DIDs;
interacting with the smart contract to initiate transactions according to requests received from user devices; and
executing, by the smart contract, the transactions upon successful verification and compliance checks.

13. The system of claim 12, wherein executing the transactions comprises:
receiving, by the smart contract deployed on the blockchain network, a transaction that transfers a first amount of a first digital asset from a user device associated with the user; and
crediting, by the smart contract, an internal ledger with a second amount of a second digital asset associated with the user's DID, wherein the second amount is determined based on the first amount.

14. The system of claim 13, wherein the operations further comprise:
updating, by the smart contract, balances in the internal ledger to reflect transactions involving the second digital asset without transferring actual tokens to user devices.

15. The system of claim 13, wherein executing the transactions further comprises:
debiting, by the smart contract, the user's balance of the second digital asset in the internal ledger upon initiation of a subsequent transaction; and
crediting, by the smart contract, a recipient's balance of the second digital asset in the internal ledger.

16. The system of claim 12, wherein the DID is issued by an authorized and regulated entity selected from the group consisting of financial institutions, government agencies, or other regulated bodies.

17. The system of claim 12, wherein the smart contract comprises an identity verification module interfacing with a distributed identity module to access DID documents and validate verifiable credentials.

18. The system of claim 12, wherein enforcing compliance rules comprises:
determining transaction limits for users based on their verified identity attributes;
rejecting transactions that exceed the determined transaction limits; or
a combination thereof.

19. The system of claim 12, wherein the smart contract is configured to:
check transactions against sanction lists obtained from authorized sources that are regularly updated;
determine whether any party involved in the transaction is identified as a sanctioned entity; and
reject the transaction if the transaction involves a sanctioned entity.

20. A non-transitory, computer-readable medium storing instructions which, when executed by a processor, cause the processor to perform operations comprising:
deploying a smart contract on a blockchain network, the smart contract configured to:
verify decentralized identifiers (DIDs) and associated verifiable credentials of users involved in transactions;
enforce compliance rules for transactions based on verified identity attributes; and
process transactions involving digital currency transfers between users based on associated DIDs;
interacting with the smart contract to initiate transactions according to requests received from user devices; and
executing, by the smart contract, the transactions upon successful verification and compliance checks.
